(19) United States
(12) Patent Application Publication
(10) Pub. No.: US 2018/0102563 A1
(43) Pub. Date: Apr. 12, 2018

(54) ELECTROLYTE STRUCTURE BODY AND METHOD OF PRODUCING ELECTROLYTE STRUCTURE BODY

(71) Applicant: TOYOTA JIDOSHA KABUSHIKI KAISHA, Toyota-shi (JP)

(72) Inventor: Yoshito ENDO, Aichi-gun (JP)

(73) Assignee: TOYOTA JIDOSHA KABUSHIKI KAISHA, Toyota-shi (JP)

(21) Appl. No.: 15/716,804

(22) Filed: Sep. 27, 2017

(30) Foreign Application Priority Data
Oct. 7, 2016 (JP) 2016-199481
Sep. 11, 2017 (JP) 2017-174397

(51) Int. Cl. H01M 8/1016; H01M 8/0289; H01M 8/0271; H01M 8/02; H01M 4/88

(52) U.S. Cl. CPC H01M 8/1016; H01M 8/0289; H01M 2300/0082; H01M 8/02; H01M 4/8875; H01M 8/0271

(57) ABSTRACT

An electrolyte structure body includes an electrolyte film and a protective film bonded to the electrolyte film. A total value of a polar component and a hydrogen bond component of surface tension of the protective film is 1 mN/m or less.

### INCORPORATION BY REFERENCE

The disclosure of Japanese Patent Application No. 2017-174397 filed on Sep. 11, 2017 including the specification, drawings and abstract is incorporated herein by reference in its entirety.

### BACKGROUND

### 1. Technical Field

The present disclosure relates to an electrolyte structure body and a method of producing an electrolyte structure body.

### 2. Description of Related Art

Since the thickness of an electrolyte film for a fuel cell is as small as several μm (several microns), and there is a possibility of tearing when only a film is transported, the electrolyte film is bonded to a protective film and transported.

Meanwhile, it is necessary to hydrophilize a side chain end of a precursor in an electrolyte film for a fuel cell. For example, a side chain end of a precursor is hydrolyzed when an electrolyte film is immersed in high temperature sodium hydroxide, and the side chain end of the precursor is hydrophilized. Thus, when the electrolyte film is rolled in a hydrolysis process, it is necessary to transport the electrolyte film in a liquid in order for the electrolyte film to be continuously immersed in sodium hydroxide. However, the electrolyte film and the protective film may separate due to the transport.

Thus, in order to prevent the electrolyte film and the protective film from separating, increasing the bonding strength between the electrolyte film and the protective film has been examined.

However, when, for example, an adhesive is used to increase the bonding strength, physical properties of the electrolyte film deteriorate. Therefore, it is necessary to increase the bonding strength without using an adhesive.

In addition, methods of improving wettability according to a plasma treatment or a corona treatment and enhancing bonding are generally known. However, if a plasma treatment or a corona treatment is performed on the electrolyte film or the protective film, the bonding strength conversely decreases.

### SUMMARY

As described above, in bonding of an electrolyte film to a protective film, this generally known relationship with wettability is not established, and a determination method thereof is unknown.

Therefore, conditions for increasing the bonding strength to an appropriate level at which an electrolyte film and a protective film do not separate in an immersion process without using an adhesive and without performing a plasma treatment or a corona treatment for improving wettability have not yet become known.

A first aspect of the present disclosure relates to an electrolyte structure body that includes an electrolyte film and a protective film bonded to the electrolyte film. In the first aspect of the present disclosure, a total value of a polar component and a hydrogen bond component of a surface tension of the protective film is 1 mN/m or less.

Because a total value of a polar component and a hydrogen bond component of the surface tension of the protective film is 1 mN/m or less, it is possible to provide an electrolyte structure body having appropriate bonding strength at which the electrolyte film and the protective film do not separate in an immersion process, and a method of producing an electrolyte structure body.

The surface tension of the protective film may be 40 mN/m or less. The surface tension of the protective film may be a total value of a dispersion component, the polar component, and the hydrogen bond component of the surface tension of the protective film.

When the surface tension of the protective film is 40 mN/m or less, it is possible to provide an electrolyte structure body having appropriate bonding strength at which the electrolyte film and the protective film do not separate in an immersion process, and a method of producing an electrolyte structure body.

A second aspect of the present disclosure relates to a method of producing an electrolyte structure body. The method of producing an electrolyte structure body includes bonding a first protective film in which a total value of a polar component and a hydrogen bond component of the surface tension is 1 mN/m or less to a first surface of a first electrolyte film precursor film; bonding a second surface of the first electrolyte film precursor film that is not bonded to the first protective film to a first surface of a porous film; forming a bonded film by impregnating an electrolyte film precursor in the first electrolyte film precursor film into the porous film; and hydrolyzing the bonded film.

By setting a total value of a polar component and a hydrogen bond component of the surface tension of the first protective film to 1 mN/m or less, it is possible to provide an electrolyte structure body having appropriate bonding strength at which the electrolyte film and the protective film do not separate in an immersion process, and a method of producing the electrolyte structure body.

The surface tension of the first protective film may be 40 mN/m or less. The surface tension of the first protective film may be a total value of a dispersion component, the polar component, and the hydrogen bond component of the surface tension of the first protective film.

By setting the surface tension of the first protective film to 40 mN/m or less, it is possible to provide an electrolyte structure body having appropriate bonding strength at which the electrolyte film and the protective film do not separate in an immersion process, and a method of producing the electrolyte structure body.

The method of producing an electrolyte structure may further include bonding a second protective film in which a total value of a polar component and a hydrogen bond component of the surface tension is 1 mN/m or less to a first surface of a second electrolyte film precursor film, and bonding a second surface of the second electrolyte film precursor film that is not bonded to the second protective film to a second surface of the porous film. The bonded film may be hydrolyzed after one of the first and second protective films is separated.

Accordingly, it is possible to prevent damage such as tearing to the film during storage or transport between impregnation and hydrophilization.

According to the present disclosure, it is possible to provide an electrolyte structure body having appropriate bonding strength at which the electrolyte film and the protective film do not separate in an immersion process, and a method of producing an electrolyte structure body.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a cross-sectional view of an electrolyte structure according to the present embodiment;

FIG. 2 is a flowchart explaining a method of producing an electrolyte structure body according to according to the present embodiment;

FIG. 3 is a cross-sectional view before bonding in the method of producing an electrolyte structure body according to the present embodiment;

FIG. 4 is a cross-sectional view during impregnation in the method of producing an electrolyte structure body according to the present embodiment;

FIG. 5 is a cross-sectional view after separation in the method of producing an electrolyte structure body according to the present embodiment;

FIG. 6 is a diagram showing hydrolysis in the method of producing an electrolyte structure body according to the present embodiment;

FIG. 7 is a graph showing the relationship between the bonding strength between an electrolyte film precursor and a protective film, and surface tension of the protective film in the electrolyte structure body according to the present embodiment; and

FIG. 8 is a graph showing the relationship between the bonding strength between an electrolyte film precursor and a protective film, and surface tension of the protective film in the electrolyte structure body according to the present embodiment.

### DETAILED DESCRIPTION OF EMBODIMENTS

(Overview of embodiment) When an electrolyte film containing fluorine that is used as a release material as a main component is bonded to a protective film, the electrolyte film and the protective film which do not easily bond to each other stick together.

Here, when the electrolyte film is hydrolyzed, hydrophilicity is imparted to the film. That is, since hydrolysis is a process that greatly changes physical properties of the film, it is conceivable that the bonding strength is also greatly changed.

In the present embodiment, the relationship between the bonding strength between an electrolyte film precursor and a protective film in an electrolyte structure body, and a total of a polar component and a hydrogen bond component of surface tension of the protective film is focused upon. In addition, in the present embodiment, the relationship between the bonding strength between an electrolyte film precursor and a protective film in an electrolyte structure body, and the surface tension of the protective film (i.e., a total of a dispersion component, a polar component, and a hydrogen bond component of the surface tension of the protective film) is focused upon.

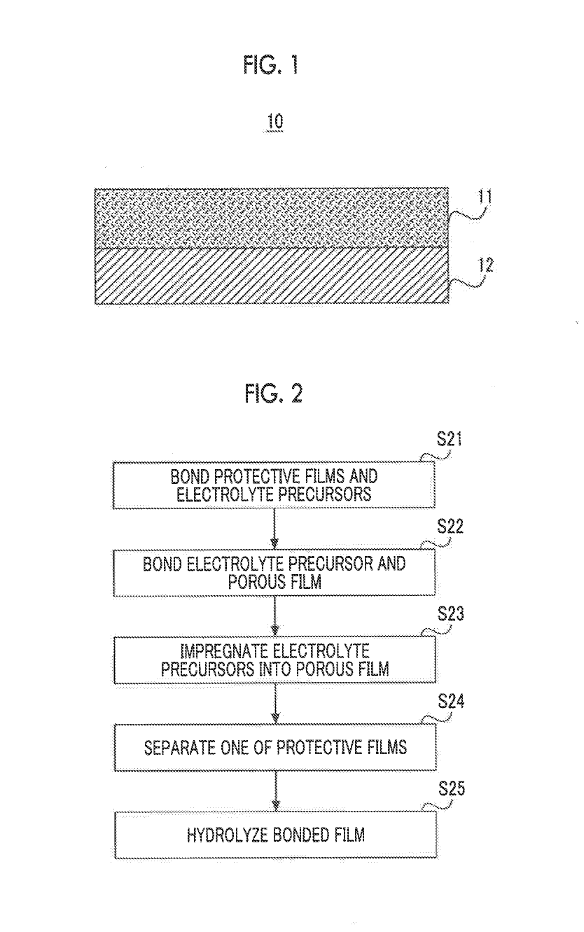

(The present embodiment) Embodiments of the present disclosure will be described below with reference to the drawings. FIG. 1 is a cross-sectional view of an electrolyte structure body according to the present embodiment. In FIG. 1, an electrolyte structure body 10 includes an electrolyte film 11 and a protective film 12.

The electrolyte film 11 is a film containing an electrolyte therein. For example, the electrolyte film 11 may contain an electrolyte in pores of a porous film. A material of the porous film is not particularly limited as long as it does not block or interfere with proton conduction and has the above characteristics. For example, an aliphatic polymer, an aromatic polymer or a fluorine-containing polymer is preferably used for the porous film. Examples of the aliphatic polymer include polytetrafluoroethylene (PTFE), polyethylene, polypropylene, polyvinyl chloride, polyvinylidene chloride, polyvinyl alcohol, and an ethylene-vinyl alcohol copolymer, but the present disclosure is not limited thereto. In addition, the electrolyte is a fluorine-based ion exchange resin, and includes, for example, a perfluorosulfonic acid polymer.

The electrolyte film 11 is bonded to at least one surface of the protective film 12. Here, a total value of a polar component and a hydrogen bond component of the surface tension of the protective film 12 is 1 mN/m or less. In addition, the surface tension of the protective film 12 (i.e., a total of a dispersion component, a polar component, and a hydrogen bond component of the surface tension of the protective film 12) is preferably 40 mN/m or less. Preferable examples of the protective film 12 include a tetrafluoroethylene-perfluoroalkyl vinyl ether copolymer film, a polytetrafluoroethylene film, a polyphenylene sulfide film, and a polyimide film in consideration of durability such as mechanical strength (high modulus of elasticity), heat resistance, acid resistance, and chemical resistance.

Next, a method of producing an electrolyte structure body of the present embodiment will he described. FIG. 2 is a flowchart explaining the method of producing an electrolyte structure body according to the present embodiment.

First, in Step S21, the protective films 12 and 13 are bonded to electrolyte film precursor films 14 and 15, and the process advances to Step S22.

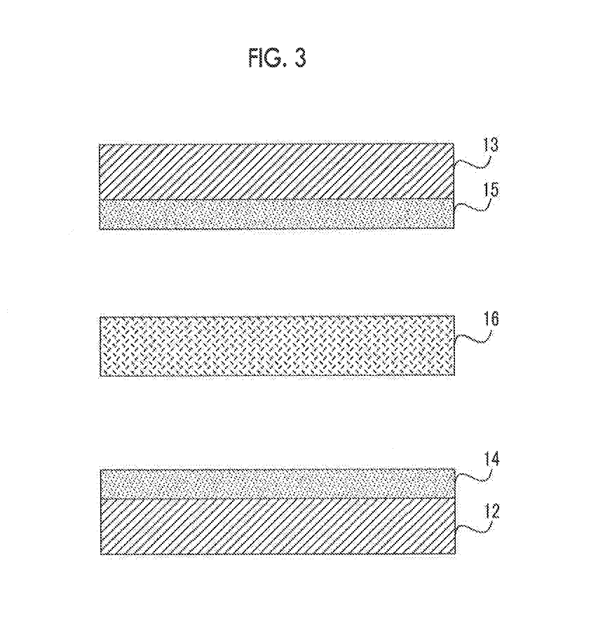

In Step S22, the electrolyte film precursor films 14 and 15 are bonded to a porous film 16, and the process advances to Step S23. FIG. 3 is a cross-sectional view before bonding in the method of producing an electrolyte structure body according to the present embodiment. As shown in FIG. 3, a surface of the electrolyte film precursor film 14 that is not bonded to the protective film 12 is bonded to the porous film 16. Similarly, a surface of the electrolyte film precursor film 15 that is not bonded to the protective film 13 is bonded to the porous film 16.

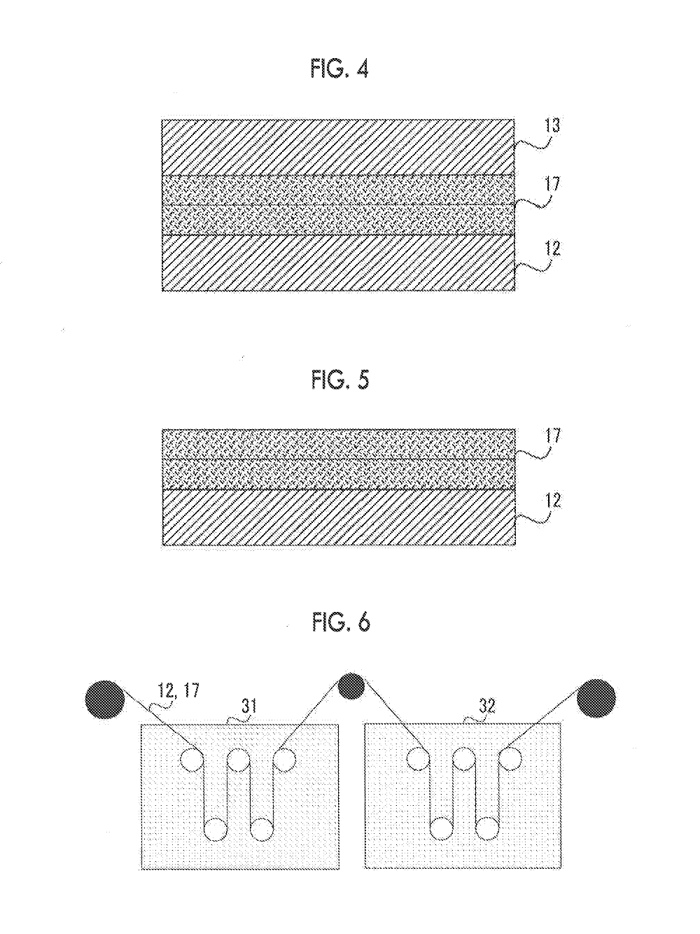

In Step S23, the electrolyte film precursor films 14 and 15 are impregnated into the porous film 16, and the process advances to Step S24. FIG. 4 is a cross-sectional view during impregnation in the method of producing an electrolyte structure body according to the present embodiment. When the electrolyte film precursor films 14 and 15 are impregnated into the porous film 16, a bonded film 17 containing an electrolyte in pores of the porous film 16 is formed. The bonded film 17 corresponds to the electrolyte film 11 in FIG. 1.

In Step S24, the protective film 13 is separated from the bonded film 17, and the process advances to Step S25. FIG. 5 is a cross-sectional view after separation in the method of producing an electrolyte structure body according to the present embodiment,

In Step S25, the bonded film 17 is hydrolyzed. Specifically, the protective film 12 and the bonded film 17 are impregnated in an alkali treatment tank. Then, the bonded film 17 is impregnated in an acid treatment tank. FIG. 6 is a diagram showing hydrolysis in the method of producing an electrolyte structure body according to the present embodiment.

First, in an alkali treatment tank 31, the following hydrophilization reaction occurs. Here, KOH may be used in place of NaOH.

CₙFₘ—SO₂F+NaOH→CₙFₘ—SO₃Na+HF

Then, in an acid treatment tank 32, the following end group substitution occurs.

CₙFₘ—SO₃Na+HNO₃→CₙFₘ—SO₂H+NaNO₃

According to the above production method, an electrolyte structure body is produced.

Next, evaluation of the electrolyte structure body will be described. First, the bonded film of the electrolyte film precursor and the protective film was evaluated as follows.
1. As protective films, films of a plurality of different types were prepared. Component analysis of the surface tension of the protective films was performed.
2. Electrolyte film precursors were placed respectively above and below the porous PTFE, the protective films were continuously bonded to the electrolyte film precursors at 180° C. with a linear pressure of 5 kN, and the electrolyte film precursors were impregnated into the porous PTFE.
3. Bonding strength between the electrolyte film precursor and the protective film was measured according to a 180° peeling method defined in JISK6854-2.

Then, a hydrolysis treatment was performed and separation was observed.
1. In the alkali tank, a KOH aqueous solution (10 N, 10 mol/dm³) was used as a chemical agent. In the acid treatment tank, HNO₃ (1 N, 1 mol/dm³) was used as a chemical agent. A reaction chamber in which the upper roller was arranged below a chemical agent was prepared.
2. The roller and the electrolyte film precursor in the chemical tank were continuously transported in a liquid, At that time, the alkali tank was heated from the outside to 80° C., and an acid treatment was performed at room temperature.
3. Separation of a bonded body of the electrolyte film precursor and the protective film was observed.

The above evaluation test results are shown in the following Table 1.

TABLE 1

| | | | | Total of | | |
|---|---|---|---|---|---|---|
| | | | | dispersion | | |
| | | | | component, | Total of | |
| | | | Hydrogen | polar component, | polar component, | |
| | Dispersion | Polar | bond | and hydrogen | and hydrogen | |
| | component | component | component | bond component | bond component | Separation |
| | (mN/m) | (mN/m) | (mN/m) | (mN/m) | (mN/m) | failure |
| Protective film 1 | 25.3 | 0 | 0.3 | 25.6 | 0.3 | No |
| (tetrafluoroethylene - | | | | | | |
| perfluoroalkyl vinyl | | | | | | |
| ether copolymer) | | | | | | |
| Protective film 2 | 27.5 | 0 | 0 | 27.5 | 0 | No |
| (polytetrafluoroethylene) | | | | | | |
| Protective film 3 | 35 | 55.3 | 10.3 | 100.6 | 65.6 | Yes |
| (polyphenylene sulfide | | | | | | |
| resin) | | | | | | |
| Protective film 4 | 38 | 0 | 0.3 | 38.3 | 0.3 | No |
| (polyphenylene sulfide | | | | | | |
| resin) | | | | | | |
| Protective film 5 (nylon | 48 | 7.5 | 4.5 | 60 | 12 | Yes |
| 6.6) | | | | | | |
| Protective film 6 (corona | 22.1 | 56.6 | 1.3 | 80 | 57.9 | Yes |
| treatment of paraffin) | | | | | | |
| Electrolyte film | 24.1 | 0 | 1.3 | 25.4 | 1.3 | — |
| precursor | | | | | | |
| Electrolyte film | 36 | 17.8 | 0.8 | 54.6 | 18.6 | — |

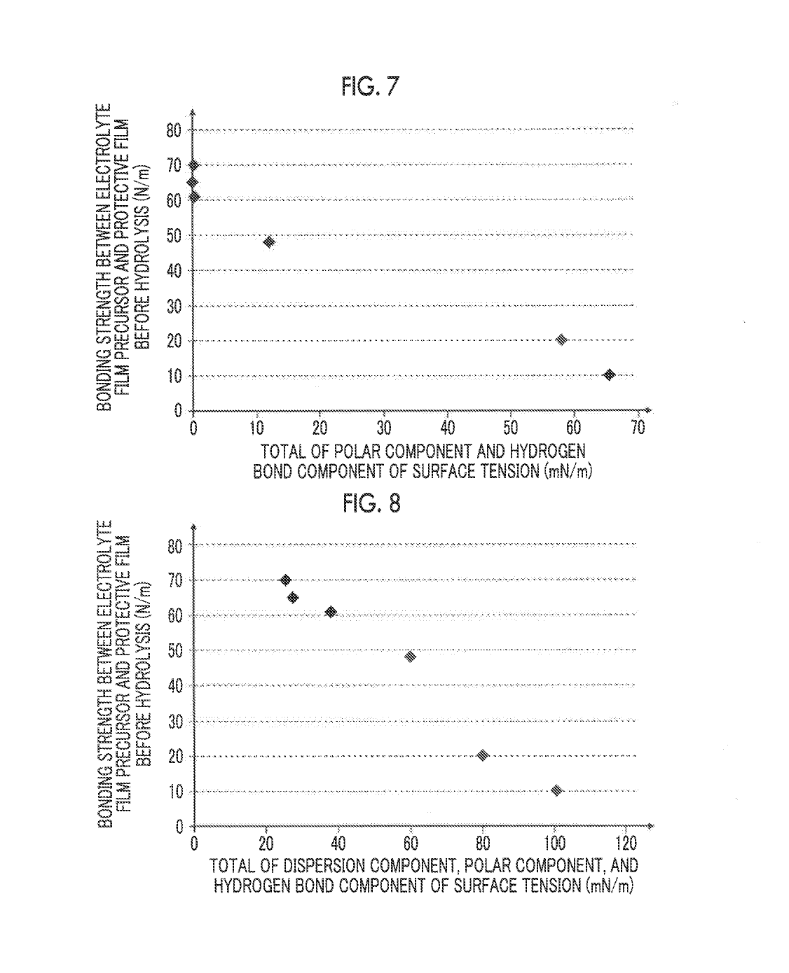

The relationship between (i) the bonding strength between the electrolyte film precursor and the protective film before hydrolysis and (ii) a total of a polar component and a hydrogen bond component of the surface tension of the protective film in Table 1 is graphically represented in FIG. 7. FIG. 7 is a graph showing the relationship between (i) the bonding strength between the electrolyte film precursor and the protective film of the electrolyte structure body according to the present embodiment and GO the surface tension of the protective film. In FIG. 7, the vertical axis represents the bonding strength (N/m) between the electrolyte film precursor and the protective film before hydrolysis, and the horizontal axis represents a total (mN/m) of a polar component, and a hydrogen bond component of the surface tension of the protective film.

As shown in FIG. 7, when a total of a polar component and a hydrogen bond component of the surface tension of the protective film is 1 mN/m or less, the bonding strength between the electrolyte film precursor and the protective film before hydrolysis is 60 N/m or more.

As described above, in the electrolyte structure body of the present embodiment, by setting a total value of a polar component and a hydrogen bond component of the surface tension of the protective film to 1 mN/m or less, it is possible to provide an electrolyte structure body having appropriate bonding strength at which the electrolyte film and the protective film do not separate in an immersion process, and a method of producing the electrolyte structure body.

In addition, the relationship between (i) the bonding strength between the electrolyte film precursor and the protective film before hydrolysis and (ii) the surface tension of the protective film (i.e., a total of a dispersion component, a polar component, and a hydrogen bond component of the surface tension) in Table 1 is graphically represented in FIG. 8. FIG. 8 is a graph showing the relationship between (i) the bending strength between the electrolyte film precursor and the protective film and (ii) the surface tension of the protective film in the electrolyte structure body according to the present embodiment. In FIG. 8, the vertical axis represents the bonding strength (N/m) between the electrolyte film precursor and the protective film before hydrolysis, and the horizontal axis represents a total (mN/m) of a dispersion component, a polar component, and a hydrogen bond component of the surface tension.

As shown in FIG. 8, when a total of a dispersion component, a polar component, and a hydrogen bond component of the surface tension is 40 mN/m or less, the bonding strength between the electrolyte film precursor and the protective film before hydrolysis is 60 N/m or more.

As shown in Table 1, FIG. 7 and FIG. 8, when the bonding strength between the electrolyte film precursor and the protective film is 60 N/m or more, separation of the electrolyte film precursor and the protective film due to hydrolysis does not occur. That is, in the 180° peeling method, when the bonding strength is maintained at 60 N/m or more, it is possible to avoid a separation failure during hydrolysis in the electrolyte film precursor and the protective film. Thus, the relationship between (components of) the surface tension of the protective film and the bonding strength was confirmed.

As described above, in the electrolyte structure body of the present embodiment, when the surface tension of the protective film is 40 mN/m or less, it is possible to provide an electrolyte structure body having appropriate bonding strength at which the electrolyte film and the protective film do not separate in an immersion process and a method of producing an electrolyte structure body.

Here, the present disclosure is not limited to the above embodiment, and can be appropriately changed. For example, while protective films are bonded to both surfaces of the porous film to which the electrolyte film precursor is bonded in the present embodiment, a protective film may be bonded to one surface, a separation process in which the protective film is separated from other surface may be omitted, and then a hydrophilic treatment may be performed. In this case, since the separation process can be omitted, the production process can be simplified.

In addition, when protective films are bonded to both surfaces of the porous film to which the electrolyte film precursor is bonded and one protective film is separated before a hydrophilic treatment, it is possible to prevent damage such as tearing to the film during storage or transport between impregnation and hydrophilization.

What is claimed is:

1. An electrolyte structure body comprising:
an electrolyte film; and
a protective film bonded to the electrolyte film,
wherein a total value of a polar component and a hydrogen bond component of surface tension of the protective film is 1 mN/m or less.

2. The electrolyte structure body according to claim 1,
wherein the surface tension of the protective film is 40 mN/m or less.

3. The electrolyte structure body according to claim 1,
wherein the surface tension of the protective film is a total value of a dispersion component, the polar component, and the hydrogen bond component of the surface tension of the protective film.

4. A method of producing an electrolyte structure body comprising:
bonding a first protective film in which a total value of a polar component and a hydrogen bond component of surface tension is 1 mN/m or less to a first surface of a first electrolyte film precursor film;
bonding a second surface of the first electrolyte film precursor film that is not bonded to the first protective film to a first surface of a porous film;
forming a bonded film by impregnating an electrolyte film precursor in the first electrolyte film precursor film into the porous film; and
hydrolyzing the bonded film.

5. The method of producing an electrolyte structure body according to claim 4,
wherein the surface tension of the first protective film is 40 mN/m or less.

6. The method of producing an electrolyte structure body according to claim 4,
wherein the surface tension of the protective film is a total value of a dispersion component, the polar component, and the hydrogen bond component of the surface tension of the first protective film.

7. The method of producing an electrolyte structure body according to claim 4, further comprising
bonding a second protective film in which a total value of a polar component and a hydrogen bond component of the surface tension is 1 mN/m or less to a first surface of a second electrolyte film precursor film, and
bonding a second surface of the second electrolyte film precursor film that is not bonded to the second protective film to a second surface of the porous film,
wherein the bonded film is hydrolyzed after one of the first and second protective films is separated.
